(19) United States
(12) Patent Application Publication
(10) Pub. No.: US 2024/0163974 A1
(43) Pub. Date: May 16, 2024

(54) HEATED AIR CIRCULATION ELECTRIC HEATING COOKING METHOD, SYSTEM AND DEVICE, AND MEDIUM

(71) Applicant: Guangzhou Qingkuai E-commerce Co., Ltd., Guangzhou (CN)

(72) Inventor: Huiqi He, Guangzhou (CN)

(21) Appl. No.: 18/301,359

(22) Filed: Apr. 17, 2023

(30) Foreign Application Priority Data
Nov. 10, 2022 (CN) 202211403065.1

(51) Int. Cl. H05B 1/02; F24C 7/08

(52) U.S. Cl. CPC H05B 1/0263; F24C 7/087

(57) ABSTRACT

The disclosure provides a heated air circulation electric heating cooking method, system and cooking device, and a medium. The method includes: controlling a cooking chamber to increase a temperature to a first cooking chamber temperature, heating a food for a first time according to the first cooking chamber temperature; acquiring a preset second cooking chamber temperature, and recording time taken for the cooking chamber to change from the first cooking chamber temperature to a second cooking chamber temperature as a first cooking period; determining a second cooking period for crisping and coloring the food according to a type of the food, determining a third cooking period according to the first cooking period, the second cooking period and a specific heat coefficient of the food; continuously heating the food being heated for a second time to a target state at the second cooking chamber temperature according to the third cooking period.

### CROSS-REFERENCE TO RELATED APPLICATION

This application claims priority of the Chinese Patent Application No. 202211403065.1, entitled “Heated Air Circulation Electric Heating Cooking Method, System and Device, and Medium”, filed on Nov. 10, 2022, the entire content of which is incorporated herein by reference.

### TECHNICAL FIELD

The present disclosure relates to the field of automatic cooking technology, and particularly relates to a heated air circulation electric heating cooking method, system and device, and a medium.

### BACKGROUND

In the relevant technical solutions, although some cooking devices are currently developing towards realizing the automatic cooking of food, most of the automatic cooking functions are implemented by fixing a temperature and time, which requires the operator to process the food into the specified specifications before implementing the automatic cooking. Furthermore, a weight sensing function is added into some cooking devices, the time and temperature required for cooking the food can be determined by sensing the weight of food; or other sensors are added to obtain more information to implement the automatic cooking. These related technical solutions may undoubtedly introduce a large number of sensors, and also cause a significant increase in related costs.

### SUMMARY

In view of this, in order to at least partially address one of the technical problems or defects mentioned above, the present disclosure aims to provide a heated air circulation electric heating cooking method, system, and cooking device, and a medium with lower cost and higher safety and without introducing other sensor devices.

In the first aspect, the present disclosure provides a heated air circulation electric heating cooking method, including: controlling a cooking chamber to increase a temperature to a first cooking chamber temperature, and heating a food for a first time according to the first cooking chamber temperature; acquiring a preset second cooking chamber temperature, and recording time taken for the cooking chamber to change from the first cooking chamber temperature to the second cooking chamber temperature as a first cooking period; determining a second cooking period for crisping and coloring the food according to a type of the food, and determining a third cooking period according to the first cooking period, the second cooking period and a specific heat coefficient of the food; and continuously heating the food being heated for a second time to a target state at the second cooking chamber temperature according to the third cooking period.

In an optional embodiment, the third cooking period satisfies a following calculation formula:

t₃=t₂+k×t₁,
where t₃ is the third cooking period, t₁ is the first cooking period, t₂ is the second cooking period for crisping and coloring the food, and k is the specific heat coefficient of the food.

In an optional embodiment, the controlling the cooking chamber to increase the temperature to the first cooking chamber temperature and heating the food for the first time according to the first cooking chamber temperature includes: controlling the first cooking chamber temperature to gradually increase, and heating the food in the cooking chamber for the first time at the gradually increasing first cooking chamber temperature.

In an optional embodiment, the continuously heating the food being heated for the second time to the target state at the second cooking chamber temperature according to the third cooking period includes: determining a third cooking chamber temperature of the cooking chamber, the third cooking chamber temperature being lower than the second cooking chamber temperature; determining a fourth cooking chamber temperature of the cooking chamber, the fourth cooking chamber temperature being higher than the third cooking chamber temperature; acquiring a fourth cooling period of the cooking chamber from the second cooking chamber temperature to the third cooking chamber temperature, and updating the first cooking period according to the fourth cooling period; and heating the food for the second time according to the updated first cooking period and the fourth cooling period.

In an optional embodiment, the heated air circulation electric heating cooking method further includes: adding the fourth cooling period, and acquiring the third cooking chamber temperature and the fourth cooking chamber temperature, the fourth cooling period being a period during which the temperature of the cooking chamber changes from the second cooking chamber temperature to the third cooking chamber temperature; updating the third cooking period according to the second cooking period for crisping and coloring the food, the first cooking period, the fourth cooling period, and the specific heat coefficient of the food; and heating the food heated for the second time to the target state at the fourth cooking chamber temperature according to the updated third cooking period.

In an optional embodiment, the updated third cooking period satisfies a following formula:

t₃=t₂+(t₀−k×Δt),
where t₃ is the third cooking period, t₂ is the second cooking period for crisping and coloring the food, k is the specific heat coefficient of the food, Δt is the fourth cooling period, and t₀ is a cooking period for crisping and coloring the maximum weight of food.

In an optional embodiment, the updated third cooking period satisfies a following formula:

t₃=t₂+k×(t₄−Δt),
where t₃ is the third cooking period, t₂ is the second cooking period for crisping and coloring the food, k is the specific heat coefficient of the food, Δt is the fourth cooling period, and t₄ is a period during which the temperature of the cooking chamber in an empty state changes from the first cooking chamber temperature to the third cooking chamber temperature.

In another aspect, the present disclosure provides a heated air circulation electric heating cooking system, including: a first unit configured to control a cooking chamber to increase a temperature to a first cooking chamber temperature, and heat a food for a first time according to the first cooking chamber temperature; a second unit configured to acquire a preset second cooking chamber temperature, and record time taken for the cooking chamber to change from the first cooking chamber temperature to the second cooking chamber temperature as a first cooking period; a third unit configured to determine a second cooking period for crisping and coloring the food according to a type of the food, and determine a third cooking period according to the first cooking period, the second cooking period and a specific heat coefficient of the food; a fourth unit configured to continuously heat the food being heated for a second time to a target state according to the third cooking period; a cooking chamber configured to hold the food; a heating element and a fan configured to form a circular heating air path in the cooking chamber; and a temperature sensor configured to acquire the temperature in the cooking chamber and the temperature of the food.

In another aspect, the present disclosure further provides a heated air circulation electric heating cooking device, including: at least one processor, and at least one memory for storing at least one program. When the at least one program is executed by the at least one processor, the at least one processor implements the heated air circulation electric heating cooking method in the first aspect.

In another aspect, the present disclosure further provides a storage medium, on which a processor executable program is stored. When the processor executable program is executed by a processor, the heated air circulation electric heating cooking method in the first aspect is implemented.

The advantages and beneficial effects of the present disclosure are provided in part in the following description, the rest of which can be understood by means of specific embodiments of the disclosure.

The present disclosure provides a heated air circulation electric heating cooking method, system and cooking device, and a medium. In the technical solution, after a series of pre-treatment of low-temperature cooking, the cooking period during which the best cooking result of the food can be achieved in the last stage can be determined by the difference value of the temperature change and heating power in the heating up stage. In the multi-stage heating process, it is not necessary to rely on the weight sensor to obtain the weight of the food. The automatic cooking can be implemented without adding a new sensor, thereby effectively reducing the cost of the intelligent cooking.

### BRIEF DESCRIPTION OF THE DRAWINGS

In order to illustrate the technical solution in the embodiments of the disclosure more clearly, accompanying drawings required in the description of the embodiments will be briefly introduced below. Obviously, the drawings described below are merely some of the embodiments of the present disclosure, those skilled in the art can obtain other drawings according to these drawings without any creative effort.

FIG. 1 is a flow chart showing a heated air circulation electric heating cooking method according to an embodiment of the present disclosure.

FIG. 2 shows a temperature variation curve in a food cooking process according to an embodiment of the present disclosure.

FIG. 3 shows a temperature variation curve in another food cooking process according to an embodiment of the present disclosure.

### DETAILED DESCRIPTION

Embodiments of the present disclosure are described in detail below. Examples of embodiments are shown in the drawings, in which the same or similar reference sings throughout indicate the same or similar elements or elements having the same or similar function. The embodiments described below with reference to the drawings are exemplary, which are intended only to explain the disclosure and are not construed as limitations to the disclosure. The number of the steps in the following embodiments is set only for the convenience of illustration, without any restriction on the sequence of steps. The sequence of execution of the steps in the embodiments can be adjusted adaptively according to the understanding of those skilled in the art.

It should be noted that although functional modules are divided in the device diagram and logical sequence is shown in the flow chart, in some cases the steps shown or described can be performed in a different order from the module division in the device or the sequence in the flow chart. The terms “first”, “second”, etc., in the specification and claims and in the accompanying drawings are utilized to distinguish similar objects and are not definitely utilized to describe a specific order or sequence.

Unless otherwise defined, all technical and scientific terms used herein have the same meaning as would normally be understood by a technical person in the art of the disclosure. The terms used herein are intended merely to describe the embodiments of the disclosure and are not intended to limit the disclosure.

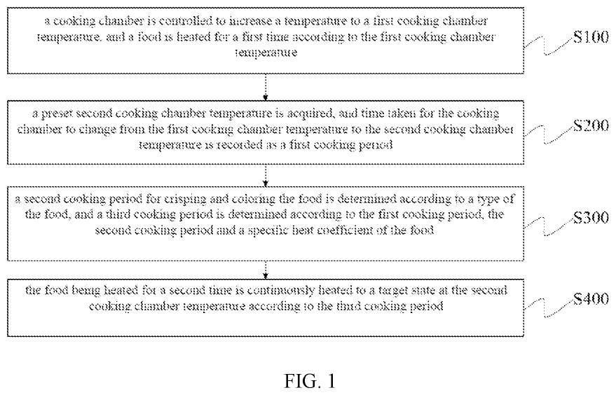

In the first aspect, a heated air circulation electric heating cooking method is provided in an embodiment of the present disclosure, which can be applied to a heated air circulation electric heating cooking device provided with a microcontroller unit, a cooking chamber, a heating element, a fan and a temperature sensor in the cooking chamber. The temperature sensor is configured to detect an ambient temperature. A circular air path is formed in the cooking chamber. When the fan operates, the air may circulate through the food first and then through the temperature sensor, so that the temperature and weight of the food may directly affect the ambient temperature perceived by the sensor, and the temperature and weight of the food combine to affect a change speed of the ambient temperature. As shown in FIG. 1, the method in the embodiment includes steps S100-S400.

S100: a cooking chamber is controlled to increase a temperature to a first cooking chamber temperature, and a food is heated for a first time according to the first cooking chamber temperature.

S200: a preset second cooking chamber temperature is acquired, and time taken for the cooking chamber to change from the first cooking chamber temperature to the second cooking chamber temperature is recorded as a first cooking period.

S300: a second cooking period for crisping and coloring the food is determined according to a type of the food, and a third cooking period is determined according to the first cooking period, the second cooking period and a specific heat coefficient of the food.

S400: the food being heated for a second time is continuously heated to a target state at the second cooking chamber temperature according to the third cooking period.

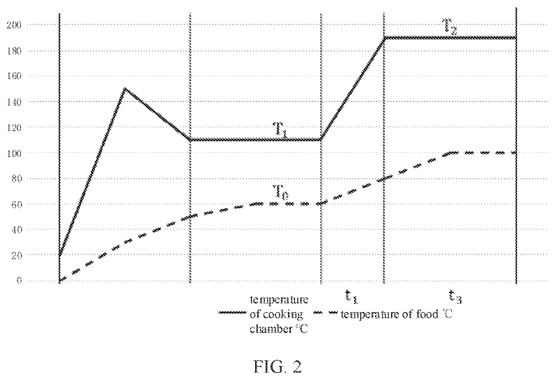

Specifically, in the embodiment, as shown in FIG. 2, the food is fully cooked by cooking at a lower temperature T₁, i.e., the first cooking chamber temperature, in order to ensure that the same kind of food can achieve the same effect regardless of the initial temperature and the weight of the food. Then, the food is cooked at a higher temperature T₂, i.e., the second cooking chamber temperature, to crisp and color a surface of the food. Since the food in different initial states can reach the same temperature T₀ after a long cooking at the temperature T₁, at the moment the heating element starts to work, and the period during which the temperature at the position of the sensor is changed from T₁ to T₂ is only related to the weight of the food, and this period is set as t₁, that is, the first cooking period; and then a period t₃, i.e., the third cooking period, is added when the temperature reaches T₂, to enable the food to reach the best effect. More specifically, in the embodiment, T₂ is greater than T₁, and the temperature value of T₁ is greater than 30° C. and less than 130° C.

In some optional embodiments, in the step that the second cooking period for crisping and coloring the food is determined according to the food type, and the third cooking period is determined according to the first cooking period, the second cooking period and the specific heat coefficient of the food, the third cooking period satisfies the following calculation formula:

t₃=t₂+k×t₁,
where, t₃ is the third cooking period, that is, the time required for the ambient temperature in the cooking chamber to change from T₁ to T₂, t₁ is the first cooking period, t₂ is the second cooking period for crisping and coloring the food, that is, the shortest time during which the food can be crisped and colored at the high temperature, and k is the specific heat coefficient of the food, which is obtained by experiment.

In some optional embodiments, the step S100 where the temperature of the cooking chamber is controlled to increase to the first cooking chamber temperature, and the food is heated for the first time according to the first cooking chamber temperature specifically further includes: controlling the first cooking chamber temperature to gradually increase, and heating the food in the cooking chamber for the first time at the gradually increasing first cooking chamber temperature.

Specifically, in the embodiment, in order to achieve a shorter cooking period, a period of high temperature cooking can be added before the food temperature reaches T₀ to accelerate the entire cooking process.

In some optional embodiments, the step S400 where the food being heated for a second time is heated to the target state at the second cooking chamber temperature according to the third cooking period may include steps S210 to S240.

S210: a third cooking chamber temperature of the cooking chamber is determined. The third cooking chamber temperature is lower than the second cooking chamber temperature.

S220: a fourth cooking chamber temperature of the cooking chamber is determined. The fourth cooking chamber temperature is higher than the third cooking chamber temperature.

S230: a fourth cooling period of the cooking chamber from the second cooking chamber temperature to the third cooking chamber temperature is acquired, and the first cooking period is updated according to the fourth cooling period.

S240: the food is heated for the second time according to the updated first cooking period and the fourth cooling period.

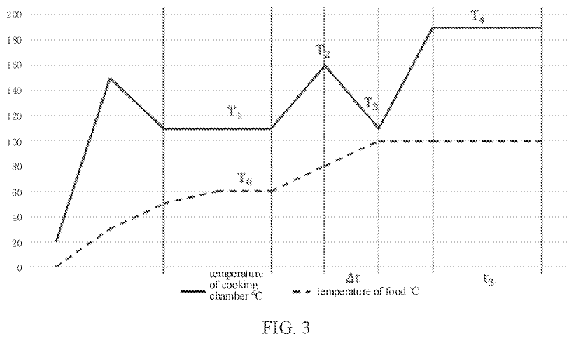

Specifically, in an embodiment as shown in FIG. 3, since the first cooking period t₁ during the heating process for the second time may be affected by a heating power fluctuation of the cooking device or a heating product, which results in a slight difference in the cooking results, in the embodiment the temperature may first increase to the second cooking chamber temperature, i.e., T₂, then the heating is stopped so that the temperature gradually decreases to the third cooking chamber temperature, i.e., T₃, and then the heating is restarted so that the temperature rises to the fourth cooking chamber temperature, i.e., T₄. The fourth cooling period from T₂ to T₃ is recorded as time Δt. Since the cooling time is not affected by the heating component, it is more accurate to use Δt to determine the final working time t₃ for heating the food to the target state. It should be noted that in some optional embodiments, the third cooking chamber temperature T₁ can be consistent with the heating temperature during the period when the food is fully cooked.

In some optional embodiment, after the cooling process is added to the embodiments, the heated air circulation electric heating cooking method may further include steps S500 to S700.

S500: the fourth cooling period is added, and the third cooking chamber temperature and the fourth cooking chamber temperature are acquired. The fourth cooling period is a period during which the temperature of the cooking chamber changes from the second cooking chamber temperature to the third cooking chamber temperature.

S600: the third cooking period is updated according to the second cooking period for crisping and coloring the food, the fourth cooling period, and the specific heat coefficient of the food.

S700: the food heated for the second time is heated to the target state at the fourth cooking chamber temperature according to the updated third cooking period.

Specifically, in the embodiment the updated third cooking period is calculated as follows:

t₃=t₂+(t₀−k×Δt),
where t₃ is the third cooking period, t₂ is the second cooking period for crisping and coloring the food, k is the specific heat coefficient of the food, Δt is the fourth cooling period, and t₀ is the cooking period for crisping and coloring the maximum weight of food, that is, the time required for crisping and coloring the maximum amount of food put in.

Alternatively, in some other optional embodiments, the updated third cooking period is calculated as follows:

t₃=t₂+k×(t₄−Δt),
where t₃ is the third cooking period, t₂ is the second cooking period for crisping and coloring the food, k is the specific heat coefficient of the food, Δt is the fourth cooling period, and t₄ is a period during which the temperature of the cooking chamber in an empty state changes from the first cooking chamber temperature to the third cooking chamber temperature, that is, the period during which the temperature of the cooking chamber decreases from T₂ to T₃ when no food is put into the cooking chamber.

The heated air circulation electric heating cooking method provided in the technical solution of the present disclosure will be completely detailed in combination with specific implementation process below.

As shown in FIG. 2, information of a kind of food selected by an operator in an interactive interface is first acquired. A microprocessor can call up a corresponding specific heat coefficient k of the food and the shortest time t₂ for crisping and coloring the food according to a preset program. And then a heating element in the cooking chamber is controlled to start working and heat the air in the whole cooking chamber at the temperature T₁. The ambient temperature reaches T₁ and is kept for a certain time so that the food achieves the cooked effect without coloring or crisping the surface. Then the ambient temperature in the cooking chamber increases from T₁ to T₂, and the period for heating up is recorded as t₁. According to a different period t₂ and a different specific heat coefficients k, after the ambient temperature in the cooking chamber reaches T₂, the cooking device is controlled to keep the ambient temperature of T₂ in the cooking chamber for an optimal period t₃ to implement the best coloring and crisping effect of food.

As shown in FIG. 3, in another embodiment, the information of a kind of food selected by the operator in the interactive interface is first acquired, and the microprocessor can call up the corresponding specific heat coefficient k of the food and the shortest time t₂ for coloring the food according to the preset program. Then the chamber operates at a full power to heat the cooking chamber to reach a temperature higher than the temperature T₁ at which the food is fully cooked, and then the heating is stopped to decrease the temperature to T₁. The on-off operation of the heating element in the cooking chamber is controlled to keep the air in the cooking chamber at the temperature T₁, and the ambient temperature reaches and maintains at T₁, so that the cooked effect of the food can be achieved without coloring and crisping the surface. The cooking device is controlled to increase the ambient temperature in the cooking chamber from T₁ to T₂, and then decrease the ambient temperature from T₂ to T₃, and record the cooling time Δt, and then increase the temperature to T₄. According to a different period Δt and a different specific heat coefficients k, when the ambient temperature in the cooking chamber reaches T₄, the cooking device is controlled to maintain the ambient temperature of T₄ in the cooking chamber for an optimal time t₃ to achieve the best coloring and crisping effect of the food.

On the other hand, the present disclosure further provides a heated air circulation electric heating cooking system, which includes: a first unit configured to control a cooking chamber to increase a temperature to a first cooking chamber temperature, and heat a food for a first time according to the first cooking chamber temperature; a second unit configured to acquire a preset second cooking chamber temperature, and record time taken for the cooking chamber to change from the first cooking chamber temperature to the second cooking chamber temperature as a first cooking period; a third unit configured to determine a second cooking period for crisping and coloring the food according to a type of the food, and determine a third cooking period according to the first cooking period, the second cooking period and a specific heat coefficient of the food; a fourth unit configured to continuously heat the food being heated for a second time to a target state according to the third cooking period; a cooking chamber configured to hold the food; a heating element and a fan configured to form a circular heating air path in the cooking chamber; and a temperature sensor configured to acquire the temperature in the cooking chamber and the temperature of the food.

On the other hand, the present disclosure further provides a heated air circulation electric heating cooking device including: at least one processor, and at least one memory for storing at least one program. When the at least one program is executed by the at least one processor, the at least one processor implements the heated air circulation electric heating cooking method described in the above second aspect.

In an embodiment of the present disclosure, a storage medium is further provided, on which a processor executable program is stored. When the processor executable program is executed by a processor, the heated air circulation electric heating cooking method in the first aspect is implemented.

From the above specific implementation process, it can be concluded that compared to the prior art, the technical solution provided by the present disclosure has the following beneficial effects or advantages.

In the technical solution of the present disclosure, there is no need to rely on a weight sensor to obtain the weight of the food in the multi-stage heating cooking process, and the automatic cooking is implemented without adding a new sensor, thereby effectively reducing the cost of the intelligent cooking.

In addition, although the present disclosure is described in the context of functional modules, it should be understood that, unless otherwise stated to the contrary, one or more of the functions and/or features can be integrated in a single physical device and/or software module, or that one or more functions and/or features can be implemented in a separate physical device or software module. It can also be understood that a detailed discussion of the actual implementation of each module is not necessary to understand the disclosure. Rather, the actual implementation of the module will be known within the normal techniques of engineers in case of the properties, functions, and internal relationships of the various functional modules in the device disclosed here. Therefore, a person skilled in the art can implement the present disclosure stated in the claim by using ordinary techniques without excessive testing. It can also be understood that the specific concepts disclosed are illustrative only and are not intended to limit the scope of the present disclosure, and the scope of the present disclosure is determined by the full scope of the attached claims and their equivalent solutions.

Logic and/or steps shown in the flow charts or otherwise described here, for example, may be regarded as a fixed sequence list of executable instructions for implementing a logical function, which may be concretely implemented in any computer-readable medium, for use by, or in combination with, an instruction executing system, apparatus, or device, such as a computer-based system, a system including a processor, or other system that can acquire and execute instructions from an instruction executing system, apparatus, or device.

In the description of the present disclosure, the reference terms “an embodiment”, “some embodiments”, “examples”, “specific examples”, or “some examples”, etc., mean that the specific features, structures, materials or characteristics described in conjunction with the embodiments or examples are included in at least one embodiment or example of the present disclosure. In the specification, schematic representations of the above terms do not definitely refer to the same embodiments or examples. Furthermore, the specific features, structures, materials or characteristics described may be combined in any one or more embodiments or examples in an appropriate manner.

Although embodiments of the present disclosure are shown and described, the ordinary technical person in the field may understand that these embodiments can be varied, modified, substituted and transformed without departing from the principle and purpose of the present disclosure, and the scope of the present disclosure is limited by the claims and their equivalents.

The above is a specific description of some embodiments of the present disclosure, but the disclosure is not limited to the above embodiments, those skilled in the art can also make a variety of equivalent transformations or substitutions without departing form the concept of the present disclosure, and such equivalent transformations or substitutions are included in the scope of the claims of the present disclosure.

What is claimed is:

1. A heated air circulation electric heating cooking method, comprising:
controlling a cooking chamber to increase a temperature to a first cooking chamber temperature, and heating a food for a first time according to the first cooking chamber temperature;
acquiring a preset second cooking chamber temperature, and recording time taken for the cooking chamber to change from the first cooking chamber temperature to the second cooking chamber temperature as a first cooking period;
determining a second cooking period for crisping and coloring the food according to a type of the food, and determining a third cooking period according to the first cooking period, the second cooking period and a specific heat coefficient of the food; and
continuously heating the food being heated for a second time to a target state at the second cooking chamber temperature according to the third cooking period.

2. The heated air circulation electric heating cooking method according to claim 1, wherein the third cooking period satisfies a following calculation formula:
t₃=t₂+k×t₁,
where t₃ is the third cooking period, t₁ is the first cooking period, t₂ is the second cooking period for crisping and coloring the food, and k is the specific heat coefficient of the food.

3. The heated air circulation electric heating cooking method according to claim 1, wherein the controlling the cooking chamber to increase the temperature to the first cooking chamber temperature and heating the food for the first time according to the first cooking chamber temperature comprises:
controlling the first cooking chamber temperature to gradually increase, and heating the food in the cooking chamber for the first time at the gradually increasing first cooking chamber temperature.

4. The heated air circulation electric heating cooking method according to claim 1, wherein the continuously heating the food being heated for the second time to the target state at the second cooking chamber temperature according to the third cooking period comprises:
determining a third cooking chamber temperature of the cooking chamber, wherein the third cooking chamber temperature is lower than the second cooking chamber temperature;
determining a fourth cooking chamber temperature of the cooking chamber, wherein the fourth cooking chamber temperature is higher than the third cooking chamber temperature;
acquiring a fourth cooling period of the cooking chamber from the second cooking chamber temperature to the third cooking chamber temperature, and updating the first cooking period according to the fourth cooling period; and
heating the food for the second time according to the updated first cooking period and the fourth cooling period.

5. The heated air circulation electric heating cooking method according to claim 4, further comprising:
adding the fourth cooling period, and acquiring the third cooking chamber temperature and the fourth cooking chamber temperature, wherein the fourth cooling period is a period during which the temperature of the cooking chamber changes from the second cooking chamber temperature to the third cooking chamber temperature;
updating the third cooking period according to the second cooking period for crisping and coloring the food, the first cooking period, the fourth cooling period, and the specific heat coefficient of the food; and
heating the food heated for the second time to the target state at the fourth cooking chamber temperature according to the updated third cooking period.

6. The heated air circulation electric heating cooking method according to claim 5, wherein the updated third cooking period satisfies a following formula:
t₃=t₂+(t₀−k×Δt),
where t₃ is the third cooking period, t₂ is the second cooking period for crisping and coloring the food, k is the specific heat coefficient of the food, Δt is the fourth cooling period, and t₀ is a cooking period for crisping and coloring the maximum weight of food.

7. The heated air circulation electric heating cooking method according to claim 5, wherein the updated third cooking period satisfies a following formula:
t₃=t₂+k×(t₄−Δt),
where t₃ is the third cooking period, t₂ is the second cooking period for crisping and coloring the food, k is the specific heat coefficient of the food, Δt is the fourth cooling period, and t₄ is a period during which the temperature of the cooking chamber in an empty state changes from the first cooking chamber temperature to the third cooking chamber temperature.

8. A heated air circulation electric heating cooking system, comprising:
a first unit configured to control a cooking chamber to increase a temperature to a first cooking chamber temperature, and heat a food for a first time according to the first cooking chamber temperature;
a second unit configured to acquire a preset second cooking chamber temperature, and record time taken for the cooking chamber to change from the first cooking chamber temperature to the second cooking chamber temperature as a first cooking period;
a third unit configured to determine a second cooking period for crisping and coloring the food according to a type of the food, and determine a third cooking period according to the first cooking period, the second cooking period and a specific heat coefficient of the food;
a fourth unit configured to continuously heat the food being heated for a second time to a target state according to the third cooking period;
a cooking chamber configured to hold the food;
a heating element and a fan configured to form a circular heating air path in the cooking chamber; and
a temperature sensor configured to acquire the temperature in the cooking chamber and the temperature of the food.

9. A heated air circulation electric heating cooking device, comprising:
at least one processor, and
at least one memory for storing at least one program,
wherein when the at least one program is executed by the at least one processor, the at least one processor implements the heated air circulation electric heating cooking method of claim 1.

10. A storage medium, on which a processor executable program is stored, wherein when the computer program is executed by a processor, the heated air circulation electric heating cooking method of claim 1 is implemented.
